(19) United States
(12) Patent Application Publication
(10) Pub. No.: US 2025/0167305 A1
(43) Pub. Date: May 22, 2025

(54) SOLID ELECTROLYTE MEMBRANE COMPRISING ADHESIVE LAYER AND RECHARGEABLE BATTERY INCLUDING THE SAME

(71) Applicant: ELETRONICS AND TELECOMMUNICATIONS RESEARCH INSTITUTE, Daejeon (KR)

(72) Inventors: Seok Hun KANG, Daejeon (KR); Jaecheol Choi, Daejeon (KR); Young-Gi Lee, Daejeon (KR); Ju Young Kim, Daejeon (KR); Young Sam Park, Daejeon (KR); Dong Ok Shin, Daejeon (KR)

(21) Appl. No.: 18/667,621

(22) Filed: May 17, 2024

(30) Foreign Application Priority Data
Nov. 16, 2023 (KR) 10-2023-0158897

(51) Int. Cl. H01M 10/0585; C09J 7/28; C09J 7/38; H01M 10/0562; H01M 10/42

(52) U.S. Cl. CPC H01M 10/0585; C09J 7/28; C09J 7/381; H01M 10/0562; H01M 10/4235; C09J 2203/33; C09J 2301/124; C09J 2301/16; C09J 2301/414; C09J 2400/163; C09J 2427/00; H01M 2300/008; H01M 2300/0097

(57) ABSTRACT

An all-solid-state battery includes a first solid electrolyte layer on the first electrode, a porous adhesive structure on the first solid electrolyte layer, a second solid electrolyte layer on the porous adhesive structure, and a second electrode on the second solid electrolyte layer. The porous adhesive structure has a porous frame with two surfaces, each covered with adhesive layers partially filling pores of the porous frame. The first adhesive layer contacts the porous frame and the first electrolyte layer, while the second adhesive layer contacts the porous frame and the second solid electrolyte layer. The first and the second solid electrolyte layers include binders, each having a content about 0.1% to about 5% by weight.

### CROSS-REFERENCE TO RELATED APPLICATION

This U.S. non-provisional patent application claims priority under 35 U.S.C. § 119 of Korean Patent Application No. 10-2023-0158897, filed on Nov. 16, 2023, the entire contents of which are hereby incorporated by reference.

### BACKGROUND

Embodiments of the present disclosure herein relate to an electrolyte membrane, and more specifically, to a solid electrolyte membrane comprising adhesive layer between the solid electrolyte layer and the porous template, and a rechargeable battery (e.g., an all-solid-state battery) including the same.

A rechargeable battery has been used in various electronic devices. However, some rechargeable batteries may use an electrolyte with a relatively high risk of ignition, and operates in a relatively high voltage range, resulting in safety issues.

Various methods for addressing the safety issues of the rechargeable battery are being developed. Recently, some solutions have used a solid electrolyte, which also functions as a separator. However, these solutions have not sufficiently addressed the needs of desirable characteristics related to performance and stability of the rechargeable battery.

### SUMMARY

The present disclosure provides an electrolyte membrane (e.g., a solid electrolyte membrane) with improved ionic conductivity and stability, and a rechargeable battery (e.g., an all-solid-state battery) including the same.

An embodiment of the present disclosure provides an all-solid-state battery including a first electrode, a first solid electrolyte layer on the first electrode, a porous adhesive structure on the first solid electrolyte layer, a second solid electrolyte layer on the porous adhesive structure, and a second electrode on the second solid electrolyte layer. The porous adhesive structure includes a porous frame having a first surface and a second surface that face each other, and including pores each extending from the first surface to the second surface, a first adhesive layer on the first surface, and a second adhesive layer on the second surface. The first adhesive layer and the second adhesive layer partially fill each of the pores of the porous frame, the first adhesive layer is in contact with the porous frame and the first solid electrolyte layer, the second adhesive layer is in contact with the porous frame and the second solid electrolyte layer, the first solid electrolyte layer includes a first binder and a first solid electrolyte, the second solid electrolyte layer includes a second binder and a second solid electrolyte, and a content of the first binder in the first solid electrolyte layer and a content of the second binder in the second solid electrolyte layer are each about 0.1% to about 5% by weight.

In an embodiment, the first and second adhesive layers may each include at least any of rubber, acryl, silicone, or urethane.

In an embodiment, the second solid electrolyte includes a material different from that of the first electrolyte.

In an embodiment, the first electrode may be a cathode, and the second electrode may be an anode, the first solid electrolyte may include a halide-based solid electrolyte, and the second solid electrolyte may include a sulfide solid electrolyte.

In an embodiment, the porous frame may include at least one of copper (Cu), aluminum (Al), nickel (Ni), stainless steel (SUS), titanium (Ti), magnesium (Mg), or zinc (Zn).

In an embodiment, the porous frame may include at least one of polyethylene (PE), polypropylene (PP), cellulose, polyethylene terephthalate (PET), polybutylene terephthalate (PBT), polyacrylonitrile (PAN), polystyrene (PS), polyvinyl chloride (PVC), polycarbonate (PC), polymethyl methacrylate (PMMA), nylon, polytetrafluoroethylene (PTFE), polyvinylidene fluoride (PVDF), a copolymer of vinylidene fluoride and hexafluoropropylene (PVDF-HFP), polyimide (PI), polyisoimide (PEI), a liquid crystal polymer film (LCP), polyoxymethylene (POM), polysiloxane, acrylonitrile butadiene styrene (ABS), an epoxy resin, a phenol resin, polysulfone (PSF), polyethersulfone (PES), or polyetheretherketone (PEEK).

In an embodiment, a diameter of each of the pores may be greater than a thickness of the porous frame.

In an embodiment, a diameter of each of the pores may be about 1 μm to about 10000 μm.

In an embodiment, a thickness of the porous frame may be about 1 μm to about 100 μm.

In an embodiment, the first solid electrolyte layer and the second solid electrolyte layer may be in contact with each other in each of the pores.

In an embodiment, the first solid electrolyte layer and the second solid electrolyte layer may be spaced apart from the porous frame by the first adhesive layer and the second adhesive layer, respectively.

In an embodiment, a content of the first binder in the first solid electrolyte layer and a content of the second binder in the second solid electrolyte layer may be each about 0.1% to about 2% by weight.

In an embodiment of the present disclosure, an all-solid-state battery includes a cathode, a first solid electrolyte layer on the cathode, a porous adhesive structure on the first solid electrolyte layer, a second solid electrolyte layer on the porous adhesive structure, and an anode on the second solid electrolyte layer, wherein the porous adhesive structure includes a porous frame having a first surface and a second surface that face each other, and including pores each extending from the first surface to the second surface, a first adhesive layer on the first surface, and a second adhesive layer on the second surface. The first adhesive layer and the second adhesive layer partially fill each of the pores of the porous frame, the first adhesive layer is in contact with the porous frame and the first solid electrolyte layer, the second adhesive layer is in contact with the porous frame and the second solid electrolyte layer, the first solid electrolyte layer includes a first binder and a first solid electrolyte, the second solid electrolyte layer includes a second binder and a second solid electrolyte different from the first solid electrolyte, a content of the first binder in the first solid electrolyte layer and a content of the second binder in the second solid electrolyte layer are each about 0.1% to about 2% by weight, the first solid electrolyte includes a halide-based solid electrolyte, and the second solid electrolyte includes a sulfide solid electrolyte.

### BRIEF DESCRIPTION OF THE FIGURES

The accompanying drawings are included to provide a further understanding of some embodiments of the present disclosure, and are incorporated in and constitute a part of this specification. The drawings illustrate some embodiments of the present disclosure and, together with the description, serve to explain principles of various embodiments of the present disclosure. In the drawings:

FIG. 1 is a cross-sectional view schematically illustrating a rechargeable battery (e.g., an all-solid-state battery) according to some embodiments of the present disclosure;

FIG. 2 is a perspective view schematically illustrating a porous adhesive structure in FIG. 1 according to some embodiments of the present disclosure;

FIG. 3 is a cross-sectional view taken along A-A′ in FIG. 2;

FIG. 4 is a graph showing peeling strengths of Example 1 according to an embodiment of the present disclosure and Comparative Example 1; and

FIG. 5 is a graph showing ionic conductivities of Examples 2, 3, and 4 according to embodiments of the present disclosure.

### DETAILED DESCRIPTION

In order to fully understand the configuration and the effect of various embodiments of the present disclosure, some embodiments of the present disclosure will be described with reference to the accompanying drawings. However, various embodiments of the present disclosure are not limited to the embodiments disclosed below, but may be implemented in various forms, and various modifications may be added. In the accompanying drawings, the components are enlarged in size for convenience of description, and the proportion of each component may be exaggerated or reduced. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C).

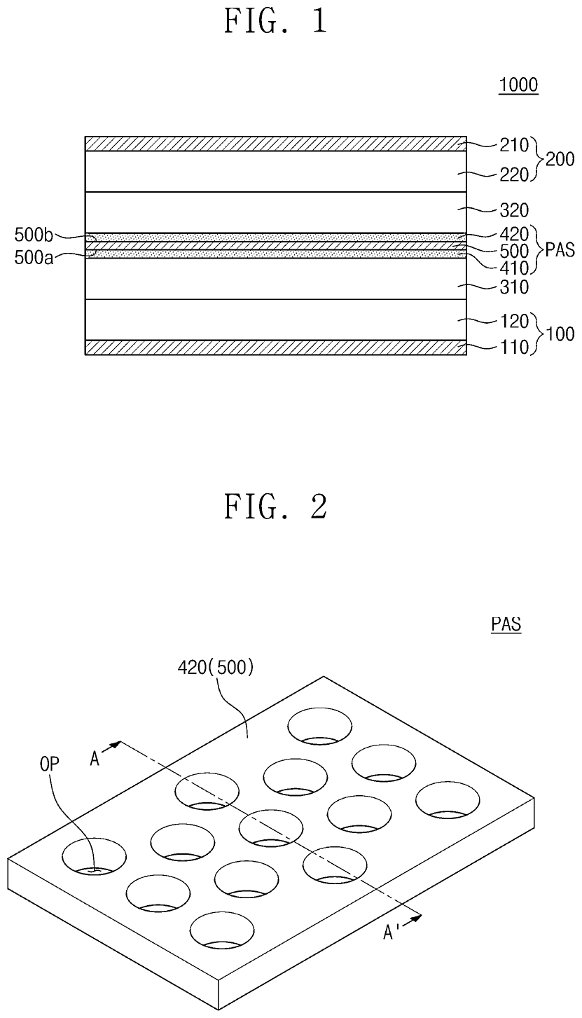

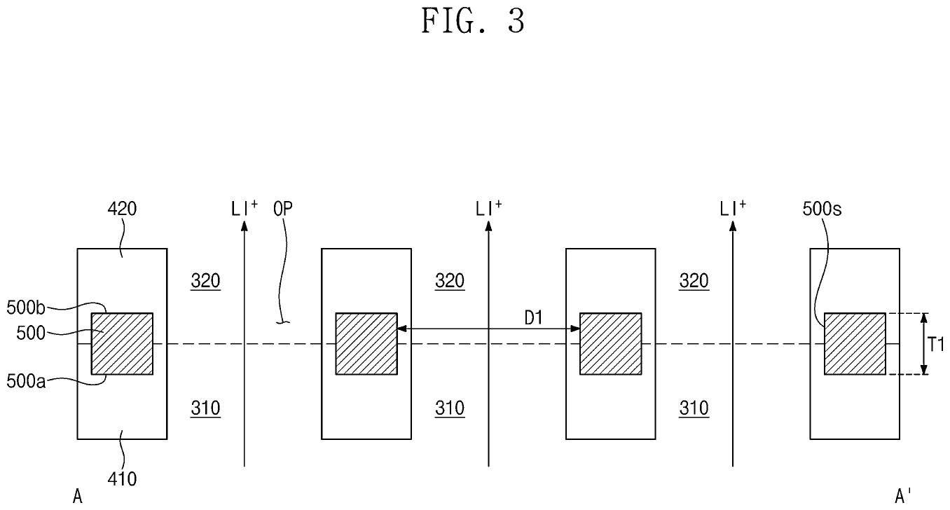

FIG. 1 is a cross-sectional view schematically illustrating a rechargeable battery (e.g., an all-solid-state battery) according to some embodiments of the present disclosure. FIG. 2 is a perspective view schematically illustrating a porous adhesive structure in FIG. 1. FIG. 3 is a cross-sectional view taken along A-A′ in FIG. 2.

Referring to FIG. 1, an all-solid-state battery 1000 according to embodiments of the present disclosure may include a first electrode 100, a second electrode 200, a first solid electrolyte layer 310, a second solid electrolyte layer 320, and a porous adhesive structure PAS.

The first electrode 100 and the second electrode 200 may be spaced apart from each other with the first solid electrolyte layer 310, the second solid electrolyte layer 320, and the porous adhesive structure PAS therebetween. The porous adhesive structure PAS may be disposed between the first solid electrolyte layer 310 and the second solid electrolyte layer 320. For example, the first solid electrolyte layer 310 may be spaced apart from the porous frame 500 by the first adhesive layer 410, and the second solid electrolyte layer 320 may be spaced apart from the porous frame 500 by the second adhesive layer 420. Unlike what is illustrated in FIG. 1, in some embodiments, the first solid electrolyte layer 310 and the second solid electrolyte layer 320 may be in contact with each other. The first solid electrolyte layer 310 may be disposed on the first electrode 100. The porous adhesive structure PAS may be disposed on the first solid electrolyte layer 310. The second solid electrolyte layer 320 may be disposed on the porous adhesive structure PAS. The second electrode 200 may be disposed on the second solid electrolyte layer 320. The term “on” in the present disclosure may be used to describe a structural relationship between two adjacent elements without or with at least one intervening element therebetween. For example, when a first element is disposed “on” a second element, the first element may be disposed directly on the second element without any intervening element, or the first element may be over the second element with one or more intervening elements between the first and second elements. The first solid electrolyte layer 310 may be disposed between the porous adhesive structure PAS and the first electrode 100. The second solid electrolyte layer 320 may be disposed between the porous adhesive structure PAS and the second electrode 200.

For example, the first electrode 100 may be a cathode. The first electrode 100 may include a first current collector (e.g., a positive current collector) 110 and a first active material layer (e.g., a positive active material layer) 120 disposed on the positive current collector 110. For example, the positive current collector 110 may include a plate, a foil, or the like composed of indium (In), copper (Cu), magnesium (Mg), stainless steel, titanium (Ti), iron (Fe), cobalt (Co), nickel (Ni), zinc (Zn), aluminum (Al), germanium (Ge), or an alloy thereof. The positive active material layer 120 may include a positive active material, a solid electrolyte, and a binder. The positive active material layer 120 may further include a conductive material. For example, the conductive material may be at least one of carbon black, acetylene black, carbon nanofiber, or carbon nanotube.

For example, the second electrode 200 may be an anode. The second electrode 200 may include a second current controller (e.g., a negative current collector) 210, and a second active material layer (e.g., a negative active material) layer 220 disposed on the negative current collector 210. For example, the negative current collector 210 is composed of a material substantially not reacting with lithium, that is, substantially not forming an alloy or a compound with lithium. For example, the negative current collector 210 may include copper (Cu), stainless steel, titanium (Ti), iron (Fe), cobalt (Co), nickel (Ni), etc. The negative current collector 210 may be composed of one among the metals described above, or an alloy of two or more metals or a material coated with two or more metals, among the metals described above. For example, the negative current collector 210 may have a form of a plate or a foil. The negative active material layer 220 may include a negative active material and a binder. According to some embodiments, the negative active material layer 220 may further include a solid electrolyte. The negative active material may include at least one of a carbon-based negative active material, a metal negative active material, or a metalloid negative active material.

The first solid electrolyte layer 310 may be disposed on the positive active material layer 120. The first solid electrolyte layer 310 may be in contact with the positive active material layer 120. The first solid electrolyte layer may include a halide-based solid electrolyte. In the present disclosure, the halide-based solid electrolyte indicates a solid electrolyte material including a halogen element, and not including sulfur(S). For example, the halide-based solid electrolyte may include at least one of Li₃YX₆, Li₂MgX₄, Li₂FeX₄, Li(Al, Ga, In)X₄, or Li₃(Al, Ga, In)X₆. Among these materials, element X is at least one selected from the group consisting of F, Cl, Br, I, and a combination thereof. “(Al, Ga, In)” represents at least one selected from the group consisting of Al, Ga, In, and a combination thereof. The same meaning is applied to other elements. X (an anion) included in the halide-based solid electrolyte includes at least one selected from the group consisting of F, Cl, Br, I and a combination thereof, and may additionally include oxygen. An ionic conductivity of the halide-based solid electrolyte may be additionally improved by the above configuration.

The second solid electrolyte layer 320 may be disposed on the negative active material layer 220. The second solid electrolyte layer 320 may be in contact with the negative active material layer 220. The second solid electrolyte layer 320 may include a sulfide solid electrolyte. For example, the sulfide solid electrolyte may include LiMS (M is at least one of P, As, Sb, Si, Ge, Sn, B, Al, Ga, In, Cl, or Br). For example, the sulfide solid electrolyte may be any one of LiPSCl, LiPSBr, or LiPSI.

The porous adhesive structure PAS may include a porous frame 500, a first adhesive layer 410, and a second adhesive layer 420.

Referring to FIGS. 2 and 3, the porous frame 500 may include a first surface 500a and a second surface 500b. The porous frame 500 may include a plurality of pores OP penetrating the inside thereof. Each of the pores OP may be an empty space extending from the first surface 500a to the second surface 500b, of the porous frame 500. For example, the porous frame 500 may include the plurality of pores OP each extending therethrough. The pores OP may be spaced apart from each other. A planar shape of a pore OP may be a circle or a shape close to a circle. A diameter D1 of the pore OP of the porous frame 500 may be about 1 μm (e.g., 0.5 to 1.4 μm) to about 10000 μm (e.g., 9995 to 10004 μm). An area or a volume, in the porous frame 500, occupied by the pores OP may be respectively greater than an area or a volume, in the porous frame 500, not occupied by the pores OP. A thickness T1 of the porous frame 500 may be about 1 μm (e.g., 0.5 to 1.4 μm) to about 100 μm (e.g., 95 to 104 μm). According to some embodiments, the diameter D1 of the pore OP may be greater than the thickness T1 of the porous frame 500.

The porous frame 500 may include a metal material. For example, the porous frame 500 may include at least one of copper (Cu), aluminum (Al), nickel (Ni), stainless steel (SUS), titanium (Ti), magnesium (Mg), or zinc (Zn). The porous frame 500 may have a foil form composed of the above metal material. The porous frame 500 may include the metal material, thereby maintaining a strength of equal to or more than a specific value, even though the pores OP have relatively great diameters and occupy a relatively large area.

According to some embodiments, the porous frame 500 may include a polymer material. For example, the porous frame 500 may include at least one of polyethylene (PE), polypropylene (PP), cellulose, polyethylene terephthalate (PET), polybutylene terephthalate (PBT), polyacrylonitrile (PAN), polystyrene (PS), polyvinyl chloride (PVC), polycarbonate (PC), polymethyl methacrylate (PMMA), nylon, polytetrafluoroethylene (PTFE), polyvinylidene fluoride (PVDF), a copolymer of vinylidene fluoride and hexafluoropropylene (PVDF-HFP), polyimide (PI), polyisoimide (PEI), a liquid crystal polymer film (LCP), polyoxymethylene (POM), polysiloxane, acrylonitrile butadiene styrene (ABS), an epoxy resin, a phenol resin, polysulfone (PSF), polyethersulfone (PES), or polyetheretherketone (PEEK). The porous frame 500 may have a film form composed of the above polymer material.

The first adhesive layer 410 may be disposed on the first surface 500a of the porous frame 500. The second adhesive layer 420 may be disposed on the second surface 500b of the porous frame 500. The first adhesive layer 410 and the second adhesive layer 420 may extend into the pores OP of the porous frame 500 to be in contact with each other. The first adhesive layer 410 and the second adhesive layer 420 may partially fill the pores OP. The first adhesive layer 410 and the second adhesive layer 420 may be respectively in contact with the first surface 500a and the second surface 500b of the porous frame 500. The first adhesive layer 410 and the second adhesive layer 420 may be in contact with an inner sidewall 500s of the porous frame 500 defining the pores OP. For example, the first adhesive layer 410 and the second adhesive layer 420 together may cover the first surface 500a, the second surface 500b, and the inner sidewalls 500s of the porous frame 500, where each of the inner sidewalls 500s defines a corresponding one of the pores OP of the porous frame 500. According to some embodiments, one or both of the first adhesive layer 410 and the second adhesive layer 420 may be omitted.

The first solid electrolyte layer 310 and the second solid electrolyte layer 320 may be in contact with each other in spaces of the pores OP that are unfilled with the first and second adhesive layers 410 and 420. For example, a porosity of the porous adhesive structure PAS, which includes the spaces to be filled with the first and second adhesive layers 410 and 420, may be in a range from about 40% (e.g., 39.5% to 40.4%) to about 70% (e.g., 69.5% to 70.4%). When the porosity of the porous adhesive structure PAS is less than about 40%, ion transport through the porous adhesive structure PAS may not be sufficient to ensure desirable charging and discharging characteristics of the battery 1000 including the porous adhesive structure PAS. When the porosity of the porous adhesive structure PAS is greater than about 70%, mechanical strength of the porous adhesive structure PAS may not be sufficient to substantially prevent damage to porous adhesive structure PAS during handling or operation of the battery 1000. The first adhesive layer 410 and the second adhesive layer 420 may each include at least one of rubber, acryl, silicone, urethane, or a combination thereof. The first adhesive layer 410 and the second adhesive layer 420 may include the same material or different materials.

The first solid electrolyte layer 310 and the second solid electrolyte layer 320 may be respectively formed on the first surface 500a and the second surface 500b of the porous frame 500 through a coating process and a curing process. For example, the coating process may be any one of slot die coating, gap coating, micro gravure coating, and comma coating. The curing process may be any one of thermal curing, photocuring using ultraviolet rays, and mixed curing mixing the thermal curing and the photocuring using ultraviolet rays.

The first solid electrolyte layer 310 and the second solid electrolyte layer 320 may include either same or different solid electrolyte materials. The binder of the first solid electrolyte layer 410 and the binder of the second solid electrolyte layer 420 may include either same or different solid electrolyte materials. According to embodiments of the present disclosure, solid electrolyte layers close to a cathode and an anode may include different solid electrolyte materials. A sulfide solid electrolyte has excellent ionic conductive characteristics, but may cause undesired side reactions with specific active materials within an operational voltage range of the battery, and thus may be difficult to apply. The first solid electrolyte layer 310 adjacent to the first electrode 100 may include the halide-based solid electrolyte, and the second solid electrolyte layer 320 adjacent to the second electrode 200 may include the sulfide solid electrolyte. Even though the halide-based solid electrolyte is in contact with or adjacent to the first electrode 100, the halide-based solid electrolyte remains stable in the presence of the positive active material, thereby substantially preventing decomposition reactions. That is, the solid electrolytes respectively stable with the cathode and the anode may be selectively disposed, thereby improving overall stability of the all-solid-state battery.

In accordance with, another aspect of embodiments of the present disclosure, the binder contents of the first solid electrolyte layer 310 and the second solid electrolyte layer 320 may be about 0.1% (e.g., 0.05% to 0.14%) to about 5% (e.g., 4.5% to 5.4%) by weight and about 0.1% to about 2% (e.g., 1.5% to 2.4%) by weight, respectively. In some embodiments, each of a content of a first binder in the first solid electrolyte layer 310 and a content of a second binder in the second solid electrolyte layer 320 may be about 0.1% to about 5% be weight. In some embodiments, each of a content of the first binder in the first solid electrolyte layer 310 and a content of the second binder in the second solid electrolyte layer 320 may be about 0.1% to about 2% be weight. In the above binder contents, ionic conductive characteristics of the first solid electrolyte layer 310 and the second solid electrolyte layer 320 may be improved. When the binder contents decrease, the ionic conductive characteristics of the first solid electrolyte layer 310 and the second solid electrolyte layer 320 may be improved. However, when the binder contents of the solid electrolyte layers are equal to or less than about 2% by weight, binding forces between the porous frame and the solid electrolyte layers may decrease, potentially leading to detachment of the solid electrolyte layers during the assembly process of the all-solid-state battery. In other words, each of the content of the first binder in the first solid electrolyte layer 310 and the content of the second binder in the second solid electrolyte layer 320 may be in a range from about 2% to about 5%. When each of the content of the first binder in the first solid electrolyte layer 310 and the content of the second binder in the second solid electrolyte layer 320 is not greater than about 2%, binding forces between the porous frame 500 and the solid electrolyte layers 310 and 320 may not be sufficient to substantially prevent detachment of the solid electrolyte layers 310 and 320 during the assembly process of the all-solid-state battery. When each of the each of the content of the first binder in the first solid electrolyte layer 310 and the content of the second binder in the second solid electrolyte layer 320 exceeds about 5%, the ionic conductive characteristics of the first solid electrolyte layer 310 and the second solid electrolyte layer 320 may not be sufficient to ensure desirable charging and discharging characteristics of the battery 1000. According to embodiments of the present disclosure, the porous frame 500 may respectively increase binding forces with the first solid electrolyte layer 310 and the second solid electrolyte layer 320 through the first adhesive layer 410 and the second adhesive layer 420. As a result, the ionic conductivity and the binding force of the all-solid-state battery may be improved together. In some embodiments, the porous frame 500 may include the metal material, thereby having a sufficient mechanical strength even when the porous frame 500 has a relatively thin thickness. However, when the porous frame 500 includes a metal material, the binder of the solid electrolyte layer may exhibit a relatively weak binding force with the metal material depending on its composition (for example, an NBR binder). Since a rechargeable battery according to embodiments of the present disclosure includes at least one adhesive layer to sufficiently increase the binding force between the solid electrolyte layer and the porous frame 500, a material of the binder in the solid electrolyte layer may be selected with a high degree of freedom.

### Example 1

A porous frame is prepared. The porous frame is made of nickel, and circular pores are regularly arranged having a specific interval. The porous frame is manufactured so that an average diameter of a pore is about 200 μm, the interval between pores is about 760 μm, porosity of the frame is about 23%, and a thickness of the frame is about 10 μm. An adhesive material is applied on both surfaces of the porous frame. The adhesive material is applied so that a thickness of the adhesive material applied on each surface of the porous frame is less than about 1 μm. Polyvinylidene fluoride-co-hexafluoropropylene (PVDF-HFP) is used as the adhesive material. A first solid electrolyte layer is formed on one surface of the porous frame which has been coated with the adhesive material. A second solid electrolyte material is formed on the other surface of the porous frame which has been coated with the adhesive material. The first solid electrolyte layer is formed through the application of a slurry comprising Li₃YBr₃Cl₃ (a halide-based solid electrolyte material), ranging from about 90% to about 99.5% by weight with respect to the total solid composition. This slurry is blended with nitrile butadiene rubber (a binder) of about 2% by weight with respect to the total solid composition. Slurry mixing is conducted in toluene (a solvent) in a solvent-to-total-solid weight ratio ranging from about 80:20 to about 30:70. For example, the ratio of toluene (the solvent) is set to about 60:40. The second solid electrolyte layer is formed through the application of a slurry comprising Li₆PS₅Cl (a sulfide-based solid electrolyte material), ranging from about 90% to about 99.5% by weight with respect to the total solid composition. This slurry is blended with nitrile butadiene rubber (a binder) of about 2% by weight with respect to the total solid. Slurry mixing is conducted in toluene (a solvent) in a solvent-to-total-solid weight ratio ranging from about 70:30 to about 30:70. For example, the ratio of toluene is set to about 55:45.

### Comparative Example 1

Except that adhesive material is not applied to the porous frame, Comparative Example 1 is prepared using the same procedure as Example 1, wherein the first solid electrolyte material and the second solid electrolyte material are directly formed on the porous frame.

### Example 2

Example 2 is prepared using the same procedure as Example 1, except that the binder content is about 0.1% by weight. Blocking electrode is formed on each side of the first solid electrolyte layer and the second solid electrolyte layer for electrochemical impedance measurement. Stainless steel (SUS) is used as the blocking electrode.

### Example 3

Example 3 is prepared using the same procedure as Example 1, except that the binder content is about 2% by weight. Blocking electrode is formed on each side of the first solid electrolyte layer and the second solid electrolyte layer for electrochemical impedance measurement. Stainless steel (SUS) is used as the blocking electrode.

### Example 4

Example 4 is prepared using the same procedure as Example 1, except that the binder content is about 5% by weight. Blocking electrode is formed on each side of the first solid electrolyte layer and the second solid electrolyte layer for electrochemical impedance measurement. Stainless steel (SUS) is used as the blocking electrode.

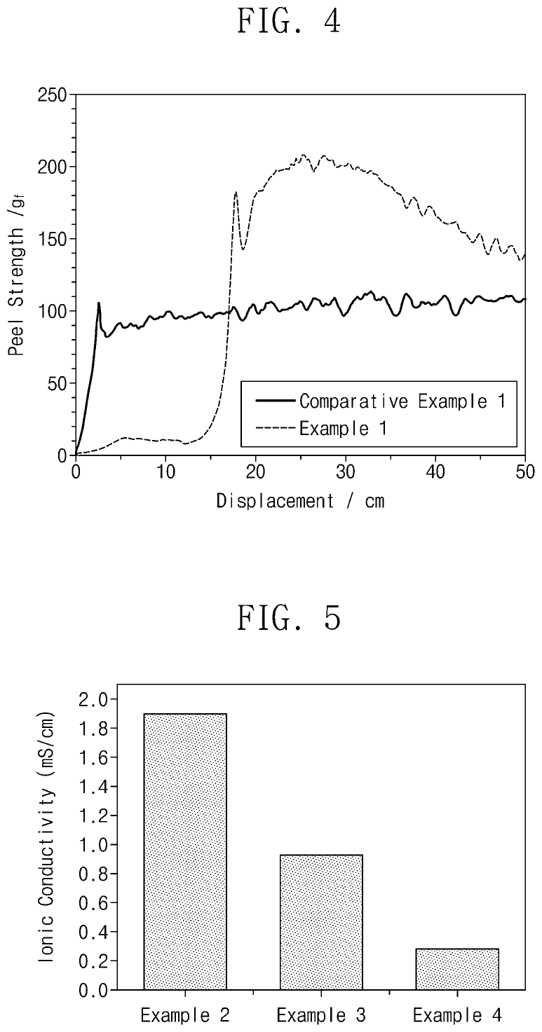

FIG. 4 is a graph showing peeling strengths of Example 1 and Comparative Example 1. The peeling strengths of the solid electrolyte layers in Example 1 and Comparative Example 1 are measured using a test device having a peeling angle of about 180°.

Referring to FIG. 4, it was confirmed that the tensile force, indicative of peeling strength, is enhanced in Example 1 compared to that observed in Comparative Example 1.

FIG. 5 is a graph showing ionic conductivities of Examples 2, 3 and 4. The ionic conductivities of Examples 2, 3, and 4 are measured using electrochemical impedance spectroscopy (EIS).

Referring to FIG. 5, it was confirmed that that a decrease in binder content correlates with an increase in ionic conductivity.

According to embodiments of the present disclosure, a solid electrolyte membrane may include a solid electrolyte layer, wherein the binder content ranges from about 0.1% to about 5% by weight, and a porous adhesive structure. When the binder content is low, the ionic conductivity of the solid electrolyte layer and the energy density of the cell may increase. In addition, the porous adhesive structure includes an adhesive layer disposed on a porous frame thereof, thereby increasing the binding force between the porous frame serving as a support, and the solid electrolyte layer.

Effects of embodiments of the present disclosure are not limited to the above descriptions of the present disclosure, and other effects not described above may be understood by those of ordinary skill in the art.

Some embodiments of the present disclosure have been described above with reference to the accompanying drawings, but various embodiments of the present disclosure may be implemented in other forms without changing the technical idea or essential features. Therefore, it should be understood that the embodiments described above are not restrictive.

What is claimed is:

1. An all-solid-state battery comprising:
a first electrode;
a first solid electrolyte layer on the first electrode;
a porous adhesive structure on the first solid electrolyte layer;
a second solid electrolyte layer on the porous adhesive structure; and
a second electrode on the second solid electrolyte layer,
wherein the porous adhesive structure includes:
a porous frame having a first surface and a second surface that face each other, and including pores each extending from the first surface to the second surface;
a first adhesive layer on the first surface; and
a second adhesive layer on the second surface,
wherein the first adhesive layer and the second adhesive layer partially fill each of the pores of the porous frame,
wherein the first adhesive layer is in contact with the porous frame and the first solid electrolyte layer,
wherein the second adhesive layer is in contact with the porous frame and the second solid electrolyte layer,
wherein the first solid electrolyte layer includes a first binder and a first solid electrolyte,
wherein the second solid electrolyte layer includes a second binder and a second solid electrolyte, and
wherein a content of the first binder in the first solid electrolyte layer and a content of the second binder in the second solid electrolyte layer are each about 0.1% to about 5% by weight.

2. The all-solid-state battery of claim 1, wherein the first and second adhesive layers each comprise at least one of rubber, acryl, silicone, or urethane.

3. The all-solid-state battery of claim 1, wherein the second solid electrolyte includes a material different from that of the first electrolyte.

4. The all-solid-state battery of claim 3, wherein the first electrode is a cathode, and the second electrode is an anode,
wherein the first solid electrolyte comprises a halide-based solid electrolyte, and
wherein the second solid electrolyte comprises a sulfide solid electrolyte.

5. The all-solid-state battery of claim 1, wherein the porous frame comprises at least one of copper (Cu), aluminum (Al), nickel (Ni), stainless steel (SUS), titanium (Ti), magnesium (Mg), or zinc (Zn).

6. The all-solid-state battery of claim 1, wherein the porous frame comprises at least one of polyethylene (PE), polypropylene (PP), cellulose, polyethylene terephthalate (PET), polybutylene terephthalate (PBT), polyacrylonitrile (PAN), polystyrene (PS), polyvinyl chloride (PVC), polycarbonate (PC), polymethyl methacrylate (PMMA), nylon, polytetrafluoroethylene (PTFE), polyvinylidene fluoride (PVDF), a copolymer of vinylidene fluoride and hexafluoropropylene (PVDF-HFP), polyimide (PI), polyisoimide (PEI), a liquid crystal polymer film (LCP), polyoxymethylene (POM), polysiloxane, acrylonitrile butadiene styrene (ABS), an epoxy resin, a phenol resin, polysulfone (PSF), polyethersulfone (PES), or polyetheretherketone (PEEK).

7. The all-solid-state battery of claim 1, wherein a diameter of each of the pores is greater than a thickness of the porous frame.

8. The all-solid-state battery of claim 1, wherein a diameter of each of the pores is about 1 μm to about 10000 μm.

9. The all-solid-state battery of claim 1, wherein a thickness of the porous frame is about 1 μm to about 100 μm.

10. The all-solid-state battery of claim 1, wherein the first solid electrolyte layer and the second solid electrolyte layer are in contact with each other in each of the pores.

11. The all-solid-state battery of claim 1, wherein the first solid electrolyte layer and the second solid electrolyte layer are spaced apart from the porous frame by the first adhesive layer and the second adhesive layer, respectively.

12. The all-solid-state battery of claim 1, wherein a content of the first binder in the first solid electrolyte layer and a content of the second binder in the second solid electrolyte layer are each about 0.1% to about 2% by weight.

13. The all-solid-state battery of claim 1, wherein a content of the first binder in the first solid electrolyte layer and a content of the second binder in the second solid electrolyte layer are each about 2% to about 5% by weight.

14. An all-solid-state battery comprising:
a cathode;
a first solid electrolyte layer on the cathode;
a porous adhesive structure on the first solid electrolyte layer;
a second solid electrolyte layer on the porous adhesive structure; and
an anode on the second solid electrolyte layer,
wherein the porous adhesive structure includes:
a porous frame having a first surface and a second surface that face each other, and including pores each extending from the first surface to the second surface;
a first adhesive layer on the first surface; and
a second adhesive layer on the second surface,
wherein the first adhesive layer and the second adhesive layer partially fill each of the pores of the porous frame,
wherein the first adhesive layer is in contact with the porous frame and the first solid electrolyte layer,
wherein the second adhesive layer is in contact with the porous frame and the second solid electrolyte layer,
wherein the first solid electrolyte layer includes a first binder and a first solid electrolyte,
wherein the second solid electrolyte layer includes a second binder and a second solid electrolyte,
wherein a content of the first binder in the first solid electrolyte layer and a content of the second binder in the second solid electrolyte layer are each about 0.1% to about 2% by weight,
wherein the first solid electrolyte includes a halide-based solid electrolyte, and
wherein the second solid electrolyte includes a sulfide solid electrolyte.

15. A rechargeable battery, comprising:
a first electrode;
a first solid electrolyte layer on the first electrode;
a porous adhesive structure on the first solid electrolyte layer;
a second solid electrolyte layer on the porous adhesive structure; and
a second electrode on the second solid electrolyte layer,
wherein the porous adhesive structure includes:
a porous frame including a plurality of pores, each of the pores extending through the porous frame; and
a first adhesive layer in contact with the porous frame and the first solid electrolyte layer, and
wherein a content of a first binder in the first solid electrolyte layer and a content of a second binder in the second solid electrolyte layer are each about 0.1% to about 5% by weight.

16. The battery of claim 15, wherein the porous adhesive structure further includes a second adhesive layer in contact with the porous frame and the second solid electrolyte layer.

17. The battery of claim 16, wherein the porous frame includes a first surface, a second surface, and a plurality of inner sidewalls, the first and second surfaces facing each other, each of the inner sidewalls defining a corresponding one of the pores of the porous frame, and
wherein the first adhesive layer and the second adhesive layer cover the first surface, the second surface, and the inner sidewalls of the porous frame to partially fill the pores.

18. The battery of claim 15, wherein the porous frame includes a metal material, and
wherein the porous adhesive structure has a porosity in a range from about 40% to about 70%.

19. The battery of claim 15, wherein the first adhesive layer comprises at least one of rubber, acryl, silicone, or urethane.

20. The battery of claim 15, wherein the content of the first binder in the first solid electrolyte layer and the content of the second binder in the second solid electrolyte layer are each about 2% to about 5% by weight.
